(19) United States
(12) Patent Application Publication
(10) Pub. No.: US 2026/0263313 A1
(43) Pub. Date: Sep. 10, 2026

(54) VEHICLES AND METHODS FOR MANUFACTURE AND USE THEREOF

(71) Applicant: Therabot Health Inc., Wilmington, DE (US)

(72) Inventor: Aaron Benjamin Aders, Menifee, CA (US)

(21) Appl. No.: 19/665,437

(22) Filed: May 1, 2026

Related U.S. Application Data
(63) Continuation of application No. PCT/US2024/054002, filed on Oct. 31, 2024.
(60) Provisional application No. 63/547,122, filed on Nov. 2, 2023.

(51) Int. Cl. A61H 15/00

(52) U.S. Cl. CPC A61H 15/0078; A61H 2201/0188; A61H 2201/5028

(57) ABSTRACT

This disclosure enables a vehicle, comprising: a cuff mountable on an elongated member such that the elongated member extends through the cuff; a first actuator attached to the cuff; a roller attached to the first actuator; a reshaper attached to the cuff, wherein the reshaper is a second actuator attached to the cuff or a spring attached to the cuff; and a power source attached to the cuff and configured to power the first actuator such that the first actuator drives the roller to move the cuff along the elongated member and the reshaper reshapes the cuff to generate a pressure towards the elongated member as the cuff moves along the elongated member.

### CROSS-REFERENCE TO RELATED PATENT APPLICATIONS

This patent application is a Continuation of International Patent Application PCT/US 2024/054002 filed 31 Oct. 2024; which claims a benefit of priority to U.S. Provisional Patent Application 63/547,122 filed 2 Nov. 2023, each of which is incorporated by reference herein in its entirety for all purposes.

### TECHNICAL FIELD

This disclosure relates to vehicles and methods of manufacture and use thereof.

### BACKGROUND

A user having a body part, such as an arm or a leg, may want the body part to be massaged by a massager. The massager may be manual, thereby requiring the user to rub, knead, compress, move, or otherwise apply at least some force to manually massage the body part while the user is awake or physically active (e.g., walking, running, jumping, swimming, parachuting, biking, skating, gaming). If the user is unable to apply such force, such as by being ill, tired, weak, disabled, or distracted, then the body part may be improperly massaged or not be massaged at all, especially if the massager is bulky. Although the massager may be automated, this configuration may still be problematic, because the massager may still require supervision, direction, or guidance by the user while the user is awake or physically active. If the user is unable to supervise, guide, or direct the massager, such as by being unsophisticated, ill, tired, weak, or disabled, then the body part may be improperly massaged or not be massaged at all, especially if the massager is bulky. Further, if the user is unsophisticated and the massager is programmed or programmable for a set of modalities of operation, such as by varying an operational setting (e.g., a speed of actuation) before or while the massager massages the body part, then the body part may be improperly massaged or not be massaged at all, especially if the massager is bulky.

### SUMMARY

This disclosure solves various technological problems described above by enabling vehicles and methods of manufacture and use thereof. For example, one of such vehicles may comprise a cuff mountable on an elongated member such that the elongated member extends through the cuff; a first actuator attached to the cuff; a roller attached to the first actuator; a reshaper attached to the cuff, where the reshaper is a second actuator attached to the cuff or a spring attached to the cuff; and a power source attached to the cuff and configured to power the first actuator such that (a) the first actuator drives the roller to move the cuff along the elongated member and (b) the reshaper reshapes the cuff to generate a pressure towards the elongated member as the cuff moves along the elongated member, although the vehicle may be configured differently, as described herein. Therefore, when the elongated member is animate, then the elongated member may be a body part (e.g., an arm, a leg, a finger, a toe, a neck, a head, a torso) or another suitable elongated member of a living object (e.g., a mammal, an animal, a pet, a bird, a fish, a human), which enables such vehicle to operate as or be a massager (e.g., an automated massager, an automated massage robot), whether on a skin (e.g., natural, artificial) or over a garment (e.g., a shirt sleeve, a pants leg, a legging, a bandage) worn, extending, or disposed over the skin, whether as a single layer or multiple layers. However, when the elongated member is inanimate, then the elongated member may be a beam, a bar, a rod, a pole, a stick, a shaft, a rail, a tube, or another suitable elongated member of a non-living object (e.g., a physical device, a doll, a showcase model, a mannequin, a toy), whether the vehicle moves on the elongated member directly or over a surface extending over the elongated member (e.g., a cover), whether as a single layer or multiple layers. For example, when the elongated member is inanimate, the elongated member may be a component involved in a step of a process (e.g., manufacturing, construction, testing, delivery, gameplay).

### DESCRIPTION OF DRAWINGS

FIG. 1 shows an exploded view of an embodiment of a vehicle according to this disclosure.

FIG. 2 shows a perspective view of an embodiment of a massager worn on a body part of a user according to this disclosure.

FIG. 3 shows an isolated view of a section of an embodiment of a vehicle according to this disclosure.

FIG. 4 shows an isolated view of a section of an embodiment of a vehicle according to this disclosure.

FIG. 5 shows a perspective view of a guide enabling an embodiment of a massager worn on a body to travel on the body part according to this disclosure.

FIG. 6 shows an isolated view of a section of an embodiment of a vehicle according to this disclosure.

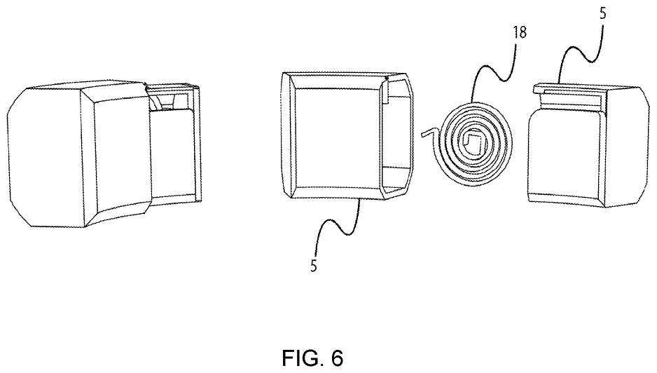

FIG. 7 shows a perspective view of an embodiment of a boot or a leg cover for use with a massager according to this disclosure.

FIG. 8 shows a perspective view of an embodiment of a section of a cuff hosting a scissor mechanism according to this disclosure.

### DETAILED DESCRIPTION

As described above, this disclosure solves various technological problems described above by enabling vehicles and methods of manufacture and use thereof. For example, one of such vehicles may comprise a cuff mountable on an elongated member such that the elongated member extends through the cuff; a first actuator attached to the cuff; a roller attached to the first actuator; a reshaper attached to the cuff, where the reshaper is a second actuator attached to the cuff or a spring attached to the cuff; and a power source attached to the cuff and configured to power the first actuator such that (a) the first actuator drives the roller to move the cuff along the elongated member and (b) the reshaper reshapes the cuff to generate a pressure towards the elongated member as the cuff moves along the elongated member, although the vehicle may be configured differently, as described herein. Therefore, when the elongated member is animate, then the elongated member may be a body part (e.g., an arm, a leg, a finger, a toe, a neck, a head, a torso) or another suitable elongated member of a living object (e.g., a mammal, an animal, a pet, a bird, a fish, a human), which enables such vehicle to operate as or be a massager (e.g., an automated massager, an automated massage robot), whether on a skin (e.g., natural, artificial) or over a garment (e.g., a shirt sleeve, a pants leg, a legging, a bandage) worn, extending, or disposed over the skin, whether as a single layer or multiple layers. However, when the elongated member is inanimate, then the elongated member may be a beam, a bar, a rod, a pole, a stick, a shaft, a rail, a tube, or another suitable elongated member of a non-living object (e.g., a device, a doll, a showcase model, a mannequin, a toy), whether the vehicle moves on the elongated member directly or over a surface extending over the elongated member (e.g., a cover), whether as a single layer or multiple layers. For example, when the elongated member is inanimate, the elongated member may be a component involved in a step of a process (e.g., manufacturing, construction, testing, delivery, gameplay).

This disclosure is now described more fully with reference to various figures that are referenced above, in which some embodiments of this disclosure are shown. This disclosure may, however, be embodied in many different forms and should not be construed as necessarily being limited to only embodiments disclosed herein. Rather, these embodiments are provided so that this disclosure is thorough and complete, and fully conveys various concepts of this disclosure to skilled persons.

Various terminology used herein can imply direct or indirect, full or partial, temporary or permanent, action or inaction, individual or collective. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

Likewise, as used herein, a term “or” is intended to mean an inclusive “or” rather than an exclusive “or.” That is, unless specified otherwise, or clear from context, “X employs A or B” is intended to mean any of natural inclusive permutations. That is, if X employs A; X employs B; or X employs both A and B, then “X employs A or B” is satisfied under any of foregoing instances.

Similarly, as used herein, various singular forms “a,” “an” and “the” are intended to include various plural forms (e.g., two, three, four, five, six, seven, eight, nine, ten, tens, hundreds) as well, unless context clearly indicates otherwise. For example, a term “a” or “an” shall mean “one or more,” even though a phrase “one or more” is also used herein.

Moreover, terms “comprises,” “includes,” “contains,” “has,” or “comprising,” “including,” “containing,” or “having” (or any tenses thereof) when used in this specification, specify a presence of stated features, integers, steps, operations, elements, or components, but do not preclude a presence and/or addition of one or more other features, integers, steps, operations, elements, components, or groups thereof. Furthermore, when this disclosure states that something is “based on” something else, then such statement refers to a basis which may be based on one or more other things as well. In other words, unless expressly indicated otherwise, as used herein “based on” inclusively means “based at least in part on” or “based at least partially on.” As used herein, relative terms such as “below,” “lower,” “above,” and “upper” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

Additionally, although terms first, second, and others can be used herein to describe various elements, components, regions, layers, subsets, diagrams, or sections, these elements, components, regions, layers, subsets, diagrams, or sections should not necessarily be limited by such terms. Rather, these terms are used to distinguish one element, component, region, layer, subset, diagram, or section from another element, component, region, layer, subset, diagram, or section. As such, a first element, component, region, layer, subset, diagram, or section discussed below could be termed a second element, component, region, layer, subset, diagram, or section without departing from this disclosure.

As used herein, a term “about” or “substantially” refers to a +/−10% variation from a nominal value/term. Such variation is always included in any given value/term provided herein, whether or not such variation is specifically referred thereto.

As used herein, a term “or others,” “combination”, “combinatory,” or “combinations thereof” refers to all permutations and combinations of listed items preceding that term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. Skilled persons understand that typically there is no limit on a number of items or terms in any combination, unless otherwise contextually apparent.

Features or functionality described with respect to certain embodiments may be combined or sub-combined in or with various embodiments in any permutational or combinatorial manner. Different aspects or elements of embodiments, as disclosed herein, may be combined or sub-combined in a similar manner. A skilled person will understand that typically there is no limit on a number of items or terms in any combination, unless otherwise contextually apparent Some embodiments, whether individually or collectively, can be components of a larger system, where other procedures can take precedence over or otherwise modify their application. Additionally, a number of steps can be required before, after, or concurrently with embodiments, as disclosed herein. Note that any or all methods or processes, at least as disclosed herein, can be at least partially performed via at least one entity in any manner.

Some embodiments are described herein with reference to illustrations of idealized embodiments (and intermediate structures) of this disclosure. As such, variations from various illustrated shapes as a result, for example, of manufacturing techniques or tolerances, are to be expected. Thus, various embodiments should not be construed as necessarily limited to various particular shapes of regions illustrated herein, but are to include deviations in shapes that result, for example, from manufacturing.

Any or all elements, as disclosed herein, can be formed from a same, structurally continuous piece, such as being unitary or monolithic, or be separately manufactured or connected, such as being an assembly or modules. Any or all elements, as disclosed herein, can be manufactured via any manufacturing processes, whether additive manufacturing, subtractive manufacturing, or any other types of manufacturing. For example, some manufacturing processes include Three Dimensional (3D) printing, laser cutting, Computer Numerical Control (CNC) routing, milling, pressing, stamping, vacuum forming, hydroforming, injection molding, lithography, fastening, adhering, nailing, stapling, threading, and so forth.

Also, unless otherwise defined, all terms (including technical and scientific terms) used herein have the same meaning as commonly understood by one of ordinary skill in an art to which this disclosure belongs. As such, terms, such as those defined in commonly used dictionaries, should be interpreted as having a meaning that is consistent with their meaning in a context of a relevant art and should not be interpreted in an idealized or overly formal sense unless expressly so defined herein.

Hereby, all issued patents, published patent applications, and non-patent publications that are mentioned or referred to in this disclosure are herein incorporated by reference in their entirety for all purposes, to a same extent as if each individual issued patent, published patent application, or non-patent publication were specifically and individually indicated to be incorporated by reference. To be even more clear, all incorporations by reference specifically include those incorporated publications as if those specific publications are copied and pasted herein, as if originally included in this disclosure for all purposes of this disclosure. Therefore, any reference to something being disclosed herein includes all subject matter incorporated by reference, as explained above. However, if any disclosures are incorporated herein by reference and such disclosures conflict in part or in whole with this disclosure, then to an extent of the conflict or broader disclosure or broader definition of terms, this disclosure controls. If such disclosures conflict in part or in whole with one another, then to an extent of conflict, the later-dated disclosure controls.

As further described below, an embodiment of a vehicle disclosed herein may be a massager, which may be an automated massage robot, configured to provide a massage in an automated way using a cuff that is compressible as the cuff moves on an elongated member (or vice versa) that is animate. For example, such movement can be at a speed of about 10 miles per hour or less such as 9, 8, 7, 6, 5, 4, 3, 2, 1, 0.5 miles per hour or less, whether the elongated member is animate or inanimate. Regardless of speed, such modality of operation may enable a provision of a diagnosis, a therapy, a forecast, a sensing, a monitoring, a treatment, an alleviation, or an amelioration of a medical condition, disorder, or disease of a user (e.g., a human, a baby, an infant, an toddler, a preschooler, a kid, a teen, an adult, an elderly, a paralyzed, a wheel-chair bound, an athlete). For example, the therapy may be a massage therapy. Since the massager may have a compact form factor, the massager can be used while the user is traveling, resting, sleeping, or physically active (e.g., walking, running, jumping, swimming, parachuting, biking, skating, gaming). For example, the massager may be beneficial for a wide range of users, addressing various health and wellness needs. For example, to individuals experiencing muscle pain, discomfort, or another suitable medical condition, disorder, or disease in their legs, arms, back, or other body parts, the massager may provide targeted massage therapy that can alleviate soreness, improve circulation, and enhance mobility. For example, the massager may have an ability to adjust in shape or size to different body parts or develop (e.g., personalize, customize) various massage techniques to address age-related muscle stiffness, pain management, or another suitable medical condition, disorder, or disease. For example, the massager may be beneficial for individuals suffering from medical conditions, disorders, or diseases, such as tendonitis or carpal tunnel syndrome. By delivering gentle, precise massage to affected areas, the massager may help reduce inflammation, alleviate pain, or promote healing by enhancing blood flow or relieving tension in muscles or tendons. For example, the massager may be enabled to have customizable settings to allow a user to select appropriate intensity levels or massage patterns suitable for sensitive or injured regions, potentially aiding in a recovery process or enabling a provision of a diagnosis, a therapy, a forecast, a sensing, a monitoring, a treatment, an alleviation, or an amelioration of a medical condition, disorder, or disease of a user. For example, the massager may assist in managing arthritis, where the massager may provide a massage to help reduce joint stiffness or improve flexibility. For those experiencing stress-related medical conditions, disorders, or diseases, such as tension headaches or anxiety, the massager may be enabled to promote relaxation through soothing massage techniques that can contribute to stress reduction or mental well-being. For example, individuals with circulatory issues may benefit from an improved blood flow resulting from regular massage sessions, potentially enhancing overall cardiovascular health or health of other bodily systems (e.g., neurological). For example, athletes or physically active individuals can utilize the massager for muscle recovery or rehabilitation. After intense training or competition, the massager can deliver deep tissue massage to specific muscle groups, aiding in a reduction of a buildup of lactic acid, decreasing muscle fatigue, or promoting faster recovery times. For example, the massager may be operated in accordance with various adaptive algorithms or customizable settings that allow some athletes to tailor their massage to their recovery needs, potentially enhancing performance or reducing a risk of injury.

Beyond various applications (e.g., therapeutic) described above, the massager may serve a general population of a defined area (e.g., a neighborhood, a city, a town, a state, a country, a planet) seeking overall health, wellness, or relaxation benefits. For example, regular use of the massager can contribute to stress reduction, improved sleep quality, or general relaxation by providing consistent or convenient massage experiences in comfort of one's home. For example, the massager may host a heat source (e.g., a heating element) thereby enabling customizable massage patterns involving provision of heat. Likewise, the massager may provide a user-friendly interface (e.g., physical, virtual) enabling its users to enjoy a spa-like experience tailored to their personal preferences or wellness goals.

In clinical or professional settings, the massager may be employed by physical therapists, chiropractors, or other healthcare providers as an adjunct tool for patient care, offering consistent and controlled massage therapy that complements manual techniques. For example, the massager (or its remote control if present) may be enabled to record or analyze session data to assist professionals in monitoring progress or adjusting treatment plans accordingly. For example, the massager may be enabled to communicate (e.g., wired, wirelessly) over a network (e.g., a local area network, a wide area network, a satellite network, a cellular network) with a remote data source (e.g., a server, a cloud computing instance, a private cloud) to make such data accessible or analyzable from or at such data source (e.g., on-demand) to a remote control (e.g., a mobile phone, a smartphone, a dumb phone, a tablet computer, a desktop computer, a laptop computer, a wearable computer, a vehicle computer).

By catering to at least some needs of elderly individuals with muscle pain, athletes requiring muscle recovery, or those seeking general health or relaxation, the massager demonstrates broad applicability, benefits, and utility. Its adaptable design and advanced technological features make the massager a valuable tool for use across various demographics and use cases, contributing positively to its user's physical well-being or quality of life.

The massager may be designed with a focus on aesthetics or ergonomics to enhance user satisfaction or comfort. The massager may feature various smooth contours and a visually appealing appearance that blends with home decor. For example, the massager may have an ergonomic design to enable the massager to conform to the body part of the user comfortably or snugly, with adjustable components that accommodate various shapes or sizes of various body parts. Controls and interfaces may be intuitively placed and designed for ease of use, even for individuals with limited dexterity or technical proficiency. For example, the massager may be available in multiple color options (e.g., to account for lighting conditions, reflectivity, phosphorescence) or finishes (e.g., smooth or textured external sides or surfaces) to suit personal preferences. Attention to both form and function may ensure that the massager is not only effective but also enjoyable to use.

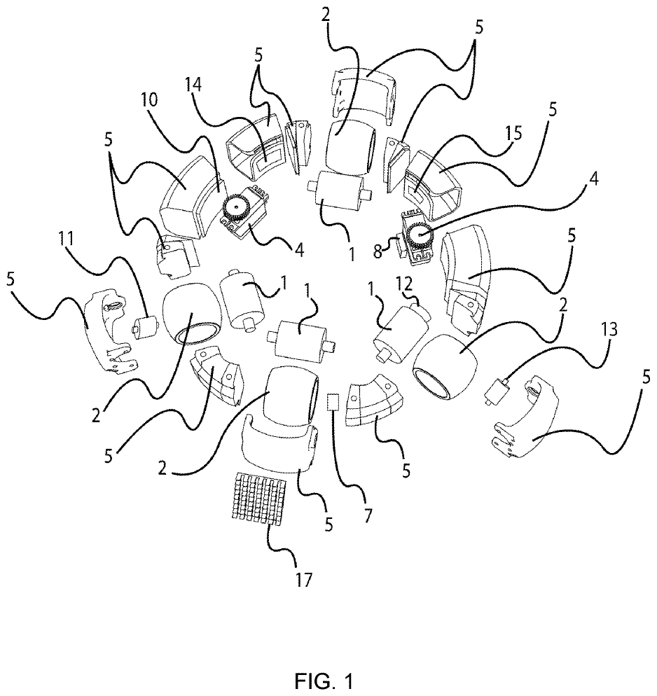

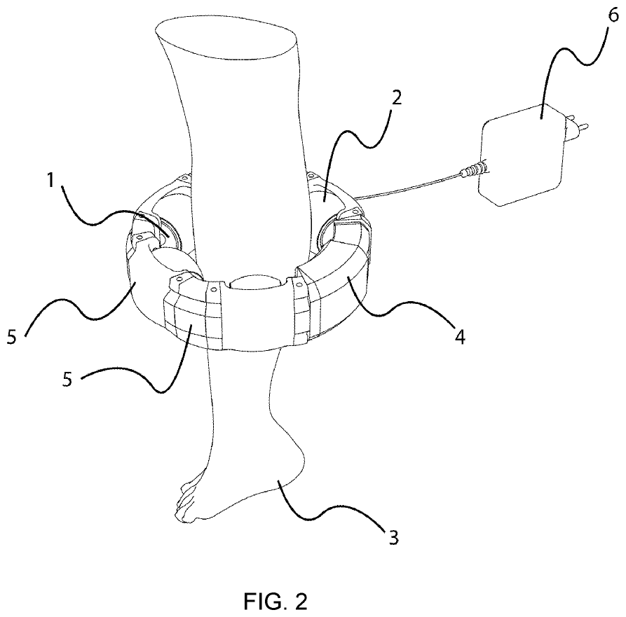

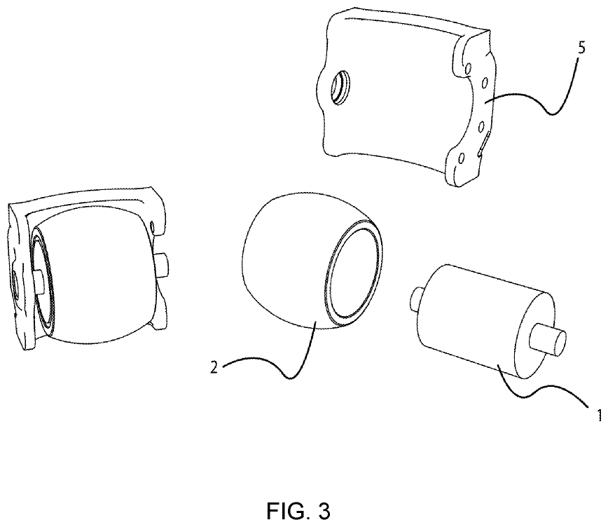

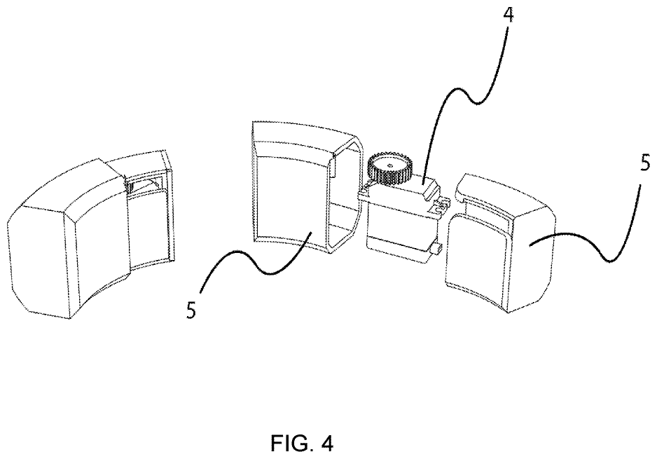

FIG. 1 shows an exploded view of an embodiment of a vehicle according to this disclosure. FIG. 2 shows a perspective view of an embodiment of a massager worn on a body part of a user according to this disclosure. FIG. 3 shows an isolated view of a section of an embodiment of a vehicle according to this disclosure. FIG. 4 shows an isolated view of a section of an embodiment of a vehicle according to this disclosure. In particular, the vehicle is embodied or operates as a massager to massage a body part (e.g., an arm, a leg, a finger, a toe, a neck, a head, a torso) or another suitable elongated member of a living object (e.g., a mammal, an animal, a pet, a bird, a fish, a human). The massager comprises an actuator 1 (first), a roller 2, an actuator 4 (second), a cuff 5, a power source 6, a microcontroller 7, a sensor 8 (first), a heat source 10, an actuator 11 (third), a sensor 12 (second), an actuator 13 (third), a sensor 14 (third), and a light source 15. As shown, the massager is wearable on a leg 3 of a user, although the massager may be wearable on another suitable body part of the user. Likewise, note that the vehicle is not required to be the massager and may be deployed on the elongated member that is inanimate, as described above. For example, when the elongated member is inanimate, then the elongated member may be a beam, a bar, a rod, a pole, a stick, a shaft, a rail, a tube, or another suitable elongated member of a non-living object (e.g., a device, a doll, a showcase model, a mannequin, a toy), whether the vehicle moves on the elongated member directly or over a surface extending over the elongated member (e.g., a cover). For example, when the elongated member is inanimate, the elongated member may be a component involved in a step of a process (e.g., manufacturing, construction, testing, delivery, gameplay). Note that the vehicle (e.g., the massager) may be scaled or sized as needed, depending on application. For example, if the vehicle is embodied as the massager for operation on the elongated part that is animate, then the vehicle may have one scale, whereas if the vehicle is not the massager for operation on the elongated member that is inanimate, then the vehicle may have another scale, whether bigger or smaller, as needed, depending on application.

The roller 2 may be attached to the actuator 1 such that the actuator 1 is located inside or outside of the roller 2. The roller 2 has a pair of opposing shafts mountable to the actuator 1, which attaches to a section of the cuff 5, as exemplified in FIG. 3. The roller 2 is or comprises a means for providing a desired hardness or softness for the massage. The roller 2 may comprise or be made from a wide variety of materials, such as foam, rubber, metal, wood, alloy, ceramic, shape-memory, fabric, or plastic. The roller 2 may be spinnable on its own axis (e.g., about 90, 180, 360 degrees) or fixed to avoid spinning on its axis. The roller 2 may have a rolling surface that is smooth, textured, treaded, knurled, or spiked. The roller 2 may be inflatable or deflatable, whether dynamically during rolling or when stationary. For example, the cuff 5 or the actuator 1 may host an on-board pump to inflate or deflate the roller 2 as disclosed herein.

Although FIG. 1 shows four rollers 2, this configuration is not required and there may be more rollers 2 (e.g., five, six, seven) or less rollers 2 (e.g., three, two, one). Likewise, although four rollers 2 are positioned in a flower arrangement (one on top and three on bottom as shown in FIG. 1), this configuration is not required and other suitable arrangements are possible. For example, some of these arrangements may be shaped as + shape, T-shape, * shape, − shape, V-shape, U-shape, C-shape, Y-shape, or other suitable shapes. Similar numbering or arrangement of actuators 1 may be applicable as well.

The massager hosts (e.g., internally or externally) the power source 6, such as a battery (e.g., removable, non-removable, rechargeable, single use, AAA, AA, coin cell) or an electronic power supply (e.g., attachable to a power cord or a data cable to receive power from an electrical socket or a port). Accordingly, the power source 6 powers the actuator 1 to drive the roller 2 unidirectionally (e.g., forward, backward) or bidirectionally (e.g., forward and backward). Therefore, the cuff 5 hosts the actuator 1 and the roller 2 such that the power source 6 powers the actuator 1 to roll the roller 2 back and forth across an external surface of the body part 3. For example, the cuff (5) may have an open-shape (e.g., C-shape, U-shape, V-shape, L-shape, J-shape, asymmetrical shape, symmetrical shape) or a closed-shape (e.g., O-shape, D-shape, 0-shape, polygonal shape, star shape, square shape, triangular shape, circular shape, oval shape, asymmetrical shape, symmetrical shape, raindrop shape) as defined by various sections, segments, components, parts, linkages, cases, holders, housing, enclosures, assemblies, or connectors shown in FIGS. 1-2. For example, the actuator 1 and the roller 2 may be operably connected or held together by the cuff 5, such as when a section of the cuff 5 has a U-shape, a C-shape, or a V-shape. For example, the actuator 1 may drive the roller 2 utilizing technologies, such as direct drive, hub drive, belt drive, chain drive, friction drive, magnetic drive, pneumatic drive, hydraulic drive, rack and pinion drive, linear actuator drive, screw drive, vibration drive, gearless motor, elastic drive, piezoelectric actuation, planetary gear drive, cable drive, oscillatory drive, thermal expansion drive, centrifugal drive, fluidic drive, electric motor (e.g., brushed or brushless), turbine, a gearbox, or another suitable technology.

The massager may use the microcontroller 7 to implement a variety of control methods and algorithms to control any actuators, sensors, transducers, or other electromechanical components thereof disclosed herein.

The actuator 4 may be configured to adjust (e.g., dynamically) at least some pressure between the roller 2 and the body part 3. The actuator 4 may achieve this functionality by expanding or contracting the cuff 5, thereby regulating at least some force exerted by the roller 2 on the body part 3 when the roller 2 is rolling on the body part 3. For example, the actuator 4 may expand or contract the cuff 5 use utilizing technologies, such as direct drive, hub drive, belt drive, chain drive, friction drive, magnetic drive, pneumatic drive, hydraulic drive, rack and pinion drive, linear actuator drive, screw drive, vibration drive, gearless motor (e.g., brushed or brushless), elastic drive, piezoelectric actuation, planetary gear drive, cable drive, oscillatory drive, thermal expansion drive, centrifugal drive, fluidic drive, electric motor (e.g., brushed or brushless), gearbox, or another suitable technology.

In some embodiments, the actuator 4 may utilize an inflatable or deflatable mechanism (e.g., an on-board pump) to adjust (e.g., dynamically) pressure between the roller 2 or the cuff 5, and the body part 3, as powered by the power source 6. For example, the cuff 5 or the roller 2 that may be inflatable or deflatable (e.g., an on-board pump powered by the power source 6).

In some embodiments, the transducer 8 may be powered by the power source 6 to measure at least some pressure between the roller 2 and the body part 3. For example, the transducer 8 may include a force sensing resistor, load cell, or any other appropriate pressure or force-sensing technology, allowing for at least some detection and monitoring of applied pressure using a variety of sensing mechanisms or devices.

The cuff 5 (e.g., assembly, housing, enclosure) may be structured to change shapes, sizes, contours, and configurations to fit multiple body parts beyond the leg 3. This adaptability allows the cuff 5 to be applied to various limbs and areas of the user, such as arms, feet, neck, shoulders, back, torso, fingers, toes, or others. The cuff 5 may include adjustable components such as expandable frames, telescoping segments, flexible joints, or modular sections that can be reconfigured to match various contours, shapes, sizes and dimensions of different body parts. The cuff 5 may utilize materials with elastic or shape-memory properties, enabling the cuff 5 to conform snugly to curved surfaces and varying anatomical shapes.

Additionally, the massager may have detachable or interchangeable attachments or accessories that can be flexible or rigid and made from or include a variety of materials (e.g., plastic, rubber, metal, glass), allowing the user to customize the cuff 5 for specific applications, thus providing a tailored fit and optimal contact with the body part 3. For example, the massager may include a locking mechanism or an adjustment system to permit easy modification of how the cuff 5 is configured without any need for tools, ensuring convenience and secure operation. The sensor 12 may be embedded within the cuff 5 and can detect a shape, a size, or a contour of the body part 3, thereby allowing the cuff 5 to automatically adjust its configuration for optimal performance via the microcontroller 7.

The massager may also accommodate an integration of specialized accessories or pads that enhance comfort or effectiveness for particular body areas. For example, the cuff 5 may support ergonomic supports for a neck of the user or curved attachments for a shoulder of the user. By incorporating these adaptable design features, the massager may offer a comprehensive massage solution capable of delivering targeted therapeutic benefits across a wide range of body parts 3. This flexibility enhances its functionality and appeal to the user seeking personalized and versatile massage experiences, making the massager suitable for use in various settings, such as home therapy, clinical rehabilitation, athletic recovery, travel therapy, sleeping, therapy, or others.

To cater to an even wider range of user needs and preferences, the massager may be designed with a highly modular architecture that allows users to customize both a massage experience and a set of specific areas of massage to suit their individual requirements. The massager may be modular by including adjustable sizing mechanisms, enabling the user to scale the massager up or down to fit different body parts, shapes, contours, or sizes, ensuring optimal contact and effectiveness whether used on a child's arm or an adult's leg, for example. A variety of interchangeable roller 2 shapes, sizes, or styles may be available, including the roller 2 with different rolling textures, orientations, shapes, firmness levels, or specialized rolling surfaces to simulate various massage techniques, such as tapping, kneading, rolling, or others. A variety of interchangeable cuff 5 shapes, sizes, or styles may be available, and can conform, adapt, or engage with specific body parts 3. This configuration may allow the user to tailor the massager's use for sensation to their specific therapeutic needs, preferences, or comfort levels.

Furthermore, the massager may have a modular design that facilitates versatility in various settings and positions, allowing the massager to provide effective massages while the user is lying down, standing up, walking, running, swimming, parachuting, climbing, jumping, exercising, gaming, biking, sitting, or another suitable activity. This adaptability makes the massager suitable for use in common scenarios, such as in an airplane, a car, an office, an apartment, a housing, or another suitable locale, thereby enhancing its practicality and convenience. Components, like adjustable supports, flexible cuff segments, and mounting accessories enable the massager to conform to different body parts and postures, ensuring secure and comfortable operation in any environment, in some embodiments. The massager may have modular components that can be easily attached or detached using quick-release mechanisms (e.g., snaps, interlocks, hook-and-loops) or magnetic connectors, permitting the user to modify the massager without any tools and swiftly adapt the massager to different use cases.

This high degree of modularity not only personalizes what type of experience the massager provides, but also fosters an accessory ecosystem, encouraging a development of third-party attachments and add-ons that can be certified for compatibility with the massager. The user may upgrade the massager by integrating new technologies or features developed after the massager was initially acquired (e.g., purchased, gifted, leased, borrowed), such as advanced sensor modules, wireless connectivity hardware, or specialized therapeutic attachments. Additional modular components might include extended or swappable (e.g., hot-swappable) battery packs for longer use during travel, ergonomic handles for handheld operation, rollers, cuff, actuator or storage solutions for organizing various attachments.

The user may be able to select their desired pressure and motion style of the massager, such as travel speed, inward pressure, massage type (e.g., rolling, kneading, tapping), or other operational parameters. This selection may occur at the massager or from a remote control (e.g., a phone, a smartphone, a tablet computer) thereof, if any, whether wired or wireless.

The massager may include the sensor 12 to determine a spatial relationship (e.g., distance traveled, distance to travel, orientation, direction) between the body part 3 and the cuff 5 (e.g., a surface thereof) or the roller 2 (e.g., a surface thereof). For example, the sensor 12 may be or employ a measurement device, a distance-determining mechanism, a range-finder, or another suitable technology. The sensor 12 may be hosted on a transducer or on the actuator 1 or the actuator 4 to track at least some motion, power, or distance traveled by the actuator 1 on the body part 3. Data from the sensor 12 measuring at least some distance traveled by the actuator 1 may be sent (e.g., wired, wirelessly) to the microcontroller 7 to determine the spatial relationship between the body part (3) and the actuator 1, the sensor 12, or the cuff 5. Data from the sensor 12 monitoring at least some rotation or movement of the actuator 1, the actuator 4, or the cuff 5 may be transmitted (e.g., wired, wirelessly) to the microcontroller 7 as the massager interacts (e.g., massages) with the body part 3. This data can be used to generate a three-dimensional representation of the body part 3 or to determine the spatial relationship between the sensor 12, the actuator 1, the actuator 12, or the cuff 5, and the body part 3.

The sensor 12 may include a capacitive sensor or other types of sensors, such as magnetic sensors, rotary encoders, infrared sensors, ultrasonic sensors, or any other suitable sensing technology, to determine the spatial relationship between the sensor 12, the actuator 1, the actuator 12, or the cuff 5, and the body part (3). These sensors may detect different materials or characteristics between the massager and the body part 3, allowing for the use of various materials or markers to identify different positions on the body part 3 or aid in determining the spatial relationship between the massager and the body part 3.

The massager hosts the microcontroller 7 (or another form factor of a processing unit) running one or more adaptive algorithms that dynamically adjust massage techniques in real-time based on sensor data, enhancing both effectiveness and personalization. Sensors embedded in the massager may continuously monitor at least some pressure applied to the body part 3. The massager may process this data using digital filters to eliminate noise and compare at least some filtered readings against predefined optimal pressure ranges stored in memory thereof (e.g., RAM, flash memory). If such pressure is below a desired threshold, then the microcontroller 7 may command an increase in electric motor (e.g., brushed or brushless) torque or speed to enhance compression; if such pressure exceeds the desired threshold, then the microcontroller 7 may command a decrease in torque or speed to reduce pressure. This type of control system ensures consistent optimal pressure throughout the massage session by the massager. The control system may be open-loop or closed-loop.

Additionally, the massager may host the sensor 14, such as an electromyography (EMG) sensor, a capacitive sensor, a load cell, a strain gauge, a pressure sensor, an accelerometer, a piezoelectric sensor, an optical sensor, a force-sensitive resistors, or another suitable sensor, to detect muscle tension, although this can be done on the remote control or the remote data source. By processing raw sensor signals through filtering, rectification, and smoothing, the microcontroller 7 may extract features, such as RMS value and zero-crossing rate. A machine learning model, such as a Support Vector Machine, may classify muscle tension levels, enabling the massager to adjust massage intensity and focus areas accordingly. Temperature sensors, when present, may further enhance adaptability by monitoring skin temperature, allowing the massager to modulate massage intensity or activate heating elements (or other heat sources) to ensure comfort and safety.

The massager may further personalize its massaging experience by learning and adapting to various individual preferences and desired motions of a particular user or set of users. The massager (or the remote control or the remote data source) may initialize user profiles by collecting initial preferences through a user interface, whether virtual (e.g., application, browser program) or mechanical (e.g., HMI), which may include preferred pressure levels, massage duration, specific focus areas, and desired motion patterns, such as tapping, kneading, or rolling. These preferences, along with sensor data, health data, and detailed session data, may be stored in non-volatile memory or secure cloud storage linked to user accounts. This stored data may encompass various metrics collected during massage sessions, such as pressure readings, muscle tension levels, heart rate, skin temperature, and other biometric indicators.

By analyzing this comprehensive data using advanced algorithms and machine learning techniques, the massager may continually refine its operation to improve performance and enhance personalization over time. This analysis may identify patterns and trends that inform adjustments to massage routines, optimize settings for individual users, and contribute to the development of new features or therapies. Additionally, this aggregated and anonymized data may hold significant value for healthcare companies, offering insights into areas, such as muscle recovery, pain management, and overall wellness. This information can support research and development efforts, inform clinical practices, and contribute to broader health and wellness advancements.

By securely storing and analyzing user preferences and session data in cloud storage, the massager not only adapts to individual users' needs, but may also leverage collective insights to enhance its effectiveness and value. This integration of cloud-based data management may enable updates and improvements that are seamlessly implemented, providing users with an evolving and increasingly sophisticated massage experience.

During each session, the massager may retrieve these preferences after user authentication and adjust its operation accordingly. The massager may utilize sensors to gather real-time feedback from the user, such as muscle tension, skin temperature, heart rate, and movement responses, allowing the massager to assess at least some effectiveness of its massage and the user's comfort level. The user may also provide explicit feedback through an interface (e.g., virtual, mechanical) or voice commands, indicating satisfaction levels or requesting adjustments.

The massager may host or access advanced artificial intelligence (Al) software or machine learning (ML) software to further enhance personalization, although such software may be hosted on the remote control or the remote data source. These Al or ML algorithms can analyze not only historical data, but also real-time contextual information to adjust massage techniques dynamically. For instance, the massager may consider time of day, recent physical activity, or ambient stress indicators to tailor its massage experience. Emotion recognition technologies, utilizing data from biometric sensors or external computing devices (e.g., tablet computers, phones, smartphones, wearable computers, watches, smartwatches, fitness trackers, activity rings, headset computers, eyewear computers, smart patches), may allow the Al to assess the user's emotional state and adjust the massage accordingly to promote relaxation or invigoration. Continuous learning algorithms may enable the massager to adapt to the user's changing needs over time, providing increasingly personalized and effective therapy. These advanced Al features enable the massager to enable personalized wellness or care.

The massager may log adjustments made during sessions and incorporate user feedback to update preferences using algorithms, such as weighted moving average. The massager may host or access Al or ML algorithms, such as artificial neural networks, decision trees, reinforcement learning models, or others, to analyze historical session data, identify trends in user preferences, or optimize performance, although such software may be hosted on the remote control or the remote data source. For example, the massager may be configured to recognize patterns, like a preference for deeper pressure in evenings or a tendency to focus on certain muscle groups after specific activities.

The massager may include automated controls (e.g., software) for starting and stopping its massage based on user-defined schedules, biometric indicators, sensors or environmental cues. The massager can communicate (e.g., synchronize) with wearable computers (e.g., watches, smartwatches, fitness trackers, activity rings, headset computers, eyewear computers, smart patches) running software logic, such as fitness or health applications, to monitor the user's activity levels, stress indicators, or sleep patterns, initiating massages when beneficial. These algorithms may predict and recommend optimal massage settings and timings, enhancing personalization over time.

The massager may accommodate multiple users by supporting at least some creation and management of individual user profiles. Each such user profile may store personalized settings, preferences, historical data, or other relevant information, ensuring that each user experiences a massage tailored to their specific needs. The massager may host or access control mechanisms, such as a physical or virtual keyboard for password protection or personal identification numbers (PINs), or a biometric reader for biometric authentication (e.g., fingerprint or facial recognition), to prevent or minimize unauthorized access to user profiles and data. This feature may enable families or groups of users to share a single massager, while maintaining privacy and personalization amongst each other. The massager may host or access a user interface (e.g., virtual or mechanical) provides an intuitive method for switching between such user profiles, and the massager may support multiple user profiles based on storage capacity. For example, the cuff 5 may have an external side hosting the user interface, which may or may not face the leg 3.

By integrating these advanced learning mechanisms and feedback systems, the massager may continuously refine its operation to provide increasingly personalized and effective massage experiences. This adaptive capability not only enhances user comfort and satisfaction, but also contributes to improved therapeutic outcomes by tailoring the massage to the user's evolving needs and preferences.

The massager may further enhance user-friendliness by integrating with off-the-shelf voice assistant platforms, such as Apple Siri, Amazon Alexa, Google Assistant or Gemini, or another suitable voice assistant platform, whether via a personal computing terminal (e.g., a desktop computer, a laptop computer, a tablet computer, a smartphone, a headset computer, an eyewear computer) or via a dedicated voice communication appliance (e.g., a smart speaker). By leveraging these existing voice recognition platforms, the massager can be controlled through natural language commands, allowing users to adjust settings, initiate or stop massage sessions, and customize preferences with minimal or without any need for physical interaction with the massager other than receiving its massage. Integration with these voice assistants may be achieved through established application programming interfaces (APIs) and communication protocols, enabling seamless connectivity between the massager and the user's smart devices (e.g., smart speakers) or home automation systems (e.g., smart home hubs). This approach not only simplifies the user interface, but also benefits from the advanced speech recognition capabilities and continuous improvements provided by these platforms. Note that the massager may host a microphone powered by the power source 6 and controlled by the microcontroller 7 to operate as above, but without utilizing the off-the-shelf voice assistant platform.

Additionally, utilizing familiar voice commands enhances accessibility for the user's if the user has mobility limitations or prefers hands-free operation. The massager may support features, such as voice authentication to ensure that only authorized users can control its functions via voice commands, thereby maintaining privacy and operational safety. This integration may also allow the massager to respond to contextual commands, schedule massage sessions through calendar applications, and receive updates or notifications via the voice assistant platform. By adopting off-the-shelf voice assistant platform, the massager provides a more convenient and intuitive user experience, reduces at least some learning curve, and increases overall user satisfaction. This integration exemplifies how the massager can incorporate widely adopted technologies to enhance functionality and user engagement.

The massager may host or access logic (e.g., hardware, software) enabling features such as advanced interfaces like voice and gesture controls to improve user-friendliness. For voice interaction, a transducer, such as a microphone or other suitable sound sensors, may capture user speech, which is then processed through noise suppression and echo cancellation, whether on the massager (e.g., the microcontroller 7), the remote control, or the remote data source. Some of such processing may use speech recognition algorithms based on Hidden Markov Models or deep neural networks to convert speech to text. For example, natural language processing (NLP) may be used to parse at least some commands to understand user intent, allowing the massager to adjust settings accordingly. For gesture control, cameras, capacitive sensors or accelerometers may capture user movements, whether hosted by the massager, the remote control, or in operational proximity of the massager. This data may be preprocessed, whether on the massager, the remote control, or the remote data source, to extract features and employ classification algorithms to recognize specific gestures, which may be mapped to control commands, enabling users to adjust the massage without physical buttons or touchscreens. However, physical switches, such as a momentary switch or latching switches, may be used for control. For example, the user may also use a mobile device (e.g., a phone, a smartphone) a tablet computer, or another suitable remote control for control of the massager.

The massager may incorporate or practice algorithms to ensure safe and comfortable operation. The massager may continuously monitor at least some relevant safety-critical sensors, such as pressure, temperature, or position sensors, to detect at least some deviations from safe operating conditions. If such sensor readings exceed predefined safety thresholds, then the massager may execute emergency protocols by immediately or gradually stopping all motion or alerting the user through visual, auditory, or vibrational signals. The massager (or the remote control or the remote data source) may log these events for diagnostic purposes. To optimize comfort, the massager may integrate user feedback, either through comfort sensors or the user interface, or adjust operational parameters, like speed, pressure, and temperature in real-time. The massager may host or access reinforcement learning algorithms to improve comfort over time by learning from user interactions.

The massager may feature connectivity hardware (e.g., network interface, communication chip, communication board, network transmitter, network receiver, network transceiver) and corresponding algorithms that enable the massager to interface with external computing devices, such as phones, smartphones, tablets, or other computing devices, whether by radio or line-of-sight (e.g., light, sound) modalities of communication. For example, the massager may activate a network interface, like a Bluetooth chip, a Wi-Fi transceiver, or another suitable connectivity hardware to discover and pair with computing devices using standard protocols. Secure communication may be established using encryption methods, like AES-256 to protect data transmission. The massager may implement RESTful APIs to allow external control and data exchange. The massager may synchronize session data by formatting such data in computer code, such as data files, structured data, JSON, XML, or other suitable data formats, and transmit such code securely to paired computing devices or cloud computing instances. This integration may enable users to control settings remotely, schedule massage sessions, and receive insights into their muscle health through connected health and wellness applications.

To maintain optimal performance in various settings, the massager may adapt to environmental conditions using transducers, sensors, or algorithms. The massager may continuously monitor ambient temperature, humidity, or light levels. If environmental conditions deviate from optimal ranges, then the massager may adjust its operation by modulating cooling or heating systems and modifying electric motor (e.g., brushed or brushless) operations to prevent overheating. The massager may alert the user if conditions may affect performance. Additionally, the massager may reduce operational noise through vibration analysis using accelerometers hosted thereon. By detecting mechanical vibrations, the massager may adjust electric motor (e.g., brushed or brushless) speed profiles to minimize resonance and employ noise-cancellation algorithms if available, whether locally on the massager or remotely via the remote control or the remote data source. The massager can also prompt maintenance if abnormal noise levels may be detected, ensuring long-term reliability.

The massager may include self-diagnosis algorithms that monitor its components to predict and prevent malfunctions. The massager may continuously collect data on electric motor (e.g., brushed or brushless) currents, temperatures, and response times to assess performance. Statistical methods or machine learning algorithms may detect anomalies by identifying deviations from normal operating parameters. The massager may host or access predictive models, such as Weibull distribution, to estimate at least some lifespan of components. When potential issues may be detected, the massager may create notifications of impending maintenance needs, allowing for proactive servicing by the user or a dedicated service team (e.g., from a supplier or a manufacturer). The massager may host or access software update algorithms that periodically check for available updates. The massager may validate update packages using checksums or digital signatures and install them safely, providing options to revert to previous versions if necessary to ensure operational integrity.

The massager may incorporate a passive compression mechanism, such as a spring, an elastic band, a rubber strap, or another suitable non-actuator or reshaping element, to provide consistent and adjustable pressure on the leg 3 (or another body part or elongated member) with minimally relying or without relying solely on electrically motorized (e.g., brushed or brushless) actuators. For example, these passive components can exert a continuous force that adapts to varying contours of the leg 3, such as a transition from an ankle to a wider portion of a calf muscle, maximizing uniform massage pressure across different areas. For example, one implementation may involve integrating a spring, such as an adjustable tension spring, a constant force spring, or an elastic band into the cuff 5. These components can be connected to the roller 2 or pressure-applying elements, exerting force that naturally conforms to a shape of the leg 3. As such, at least some elasticity of the spring or the elastic band may allow those to stretch or contract in response to changes in the leg 3 contours, maintaining consistent pressure with minimal or without any need for active adjustments. This design reduces complexity and power consumption by minimizing reliance on electrically motorized (e.g., brushed or brushless) actuators for pressure control. For example, to provide adjustability in pressure, the massager may include mechanisms that allow users to modify at least some tension of the spring or the elastic band. For example, the cuff 5 may feature a locking slider, an adjustable hook, a ratchet system, or another suitable mechanical mechanism, that lets the user to increase or decrease at least some stretch of the spring or the elastic components, thereby controlling at least some amount of compression force applied. This manual adjustment enables the user to customize at least some massage intensity according to their comfort level and therapeutic needs.

Additionally, the massager may incorporate a series of interconnected panels or segmented frames connected by flexible joints and tensioned by a set of elastic components. This structure allows the massager to articulate and conform to complex body shapes while distributing pressure evenly. Padding or contoured surfaces on the roller 2 and contact points can further enhance at least some ability of the massager to adapt to anatomical variations, maximizing effective massage delivery across desired areas.

In combination with the passive compression mechanism described above, the actuator 1 may focus on controlling at least some motion (e.g., along X, Y, or Z axis) of the roller 2 along the leg 3, performing massage movements, such as rolling, kneading, or tapping. By separating at least some functions of pressure application and motion control, the massager may achieve efficient operation with reduced mechanical complexity. Sensors can still be utilized to monitor at least some pressure and ensure that such pressure remains within safe and effective ranges, providing feedback to the user or triggering alerts if adjustments are necessary.

These configurations leveraging springs, rubber straps, elastic bands, or similar suitable non-actuator methods may offer a simpler, energy-efficient solution for consistent pressure application in the massager. Therefore, these configurations may enhance the massager's adaptability to different body part contours and provide the user with at least some ability to easily adjust massage pressure, thereby improving user comfort and overall effectiveness of its massage.

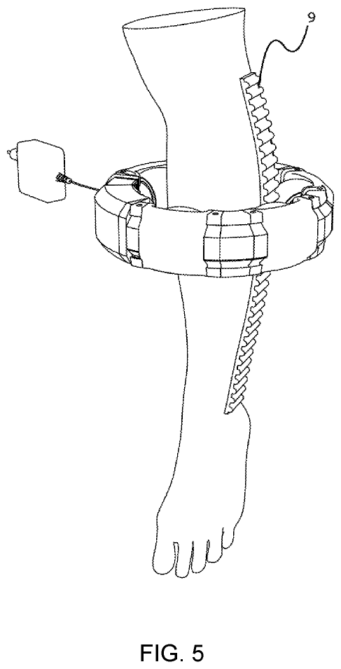

FIG. 5 shows a perspective view of a guide enabling an embodiment of a massager worn on a body to travel on the body part according to this disclosure. In particular, the massager may comprise a guide 9 (e.g., a track, a rail, a bar, a beam, a shaft) configured to direct the cuff 5 along the leg 3 hosting the guide 9, thereby ensuring precise alignment and consistent contact during massage, with the cuff 5 being structurally adapted accordingly for the guide 9 to pass underneath the cuff 5 or through the cuff 5. For example, the guide 9 may include various mechanisms, such as a track, a beam, a belt, a rail, a toothed bar, a ratchet, or another suitable mechanism, that may be positionally fixed or adjustable, whether rectilinear or non-rectilinear (e.g., arcuate, sinusoidal) allowing the cuff 5 to follow a predetermined path along the leg 3. These guide 9 tracks can be designed to accommodate different body shapes and sizes. Additionally, traction-enhancing surfaces may be utilized, incorporating specialized materials that increase friction between the massager and the leg 3, preventing slippage and promoting smooth movement.

The guide 9 may persist in its location or orientation on the leg 3 in various ways, such as adhesives, glues, stickers, friction, magnets, fasteners, belts, clamps, or other suitable ways. Although the guide 9 is shown hosted on the leg 3, this configuration is not required and the guide 9 may be hosted on another body part (e.g., an arm). Likewise, although the guide 9 is shown hosted on a skin of the leg 3, this configuration is not required and the guide 9 may be hosted on a surface extending over the leg 3 (e.g., a garment, a shirt sleeve, a pants leg, a legging, a bandage). Similarly, when the elongated member is inanimate, then the guide 9 can be hosted on a surface of the elongated member directly or indirectly (e.g., a cover extending between the guide 9 and the cuff 5).

The guide 9 extends vertically but can be positioned to extend horizontally or diagonally. Various flexible or conformable structures made of adaptable materials can serve as the guide 9, enabling the massager to navigate over curves and varying topographies by conforming to the contours of the leg 3, although the guide 9 may be rigid. Belts, straps, hook-and-loop fasteners, or harnesses may act as securing mechanisms that hold the cuff 5 in place and guide its movement along the leg 3, adjustable to fit various limb sizes. Magnetic or suction mechanisms can be employed as attachment systems, using magnetic forces or suction cups to keep the cuff 5 aligned and in contact with the leg 3.

Sensor-based guidance systems may be another possible implementation, involving at least some incorporation of a transducer or a sensor, such as optical, infrared, ultrasonic, capacitive, resistive or tactile, that detect a position or an orientation of the cuff 5 relative to the leg 3, allowing for real-time adjustments. Programmable pathways provide software-controlled guides that enable the cuff 5 to follow customized massage paths tailored to individual user preferences or specific therapeutic needs. Grooves or indentations may be included as physical features on the cuff 5 or the guide 9 or an accessory, interlocking with corresponding features on a wearable sleeve or pad placed on the leg 3 to ensure alignment.

Mechanical arms or supports having articulated arms or support structures can hold the cuff 5 and guide its movement along the desired path. Adjustable alignment mechanisms may allow the guide 9 to be adjusted manually or automatically to accommodate movement of the leg 3 or changes in posture. Safety features, integrated into the guide 9 may prevent the cuff 5 from deviating from its intended path or applying excessive pressure, thus enhancing user safety. The guide 9 may be detachable or removable to offer convenience and portability, allowing the guide 9 to be easily attached or detached from the cuff 5 or the leg 3.

Note that although the cuff 5 moves relative to the guide 9 being stationary, this configuration is not required. As such, the guide 9 may move relative to the cuff 5 being stationary. This modality of movement may be applicable whether elongated member is animate or inanimate. For example, such movement can be at a speed of about 10 miles per hour or less such as 9, 8, 7, 6, 5, 4, 3, 2, 1, 0.5 miles per hour or less, whether the elongated member is animate or inanimate.

A combination of mechanical and software components may be utilized to form hybrid systems where mechanical guides 9 may be supplemented with software algorithms that adjust a trajectory of the cuff 5 based on a sensor input. By incorporating one or more of these hybrid systems, the massager can more effectively or efficiently massage the leg 3, providing a personalized and consistent massage experience. These hybrid systems, just like the guide 9, maximize that the massager maintains optimal contact with the leg 3, adapts to individual anatomical differences, and follows a desired massage pattern with minimal or without a manual intervention, thereby enhancing an overall performance of the massager and contributing to improved therapeutic outcomes.

The massager may be designed without the actuator 1 controlling the roller 2 movement along the leg 3. Instead, the user may manually move the cuff 5 to massage, guiding the cuff 5 over a desired area at their own pace and pressure. The roller (2) may be freely rotatable, mounted on bearings or low-friction axles to allow smooth rolling motion as the cuff 5 is moved manually by the user. This hands-on approach may provide the user with direct control over massaging the desired area and speed, enabling a personalized experience.

While such rolling and travel motion may be user-controlled, the massager may retain the actuators 4 to manage a compression force exerted by the roller 2 onto the leg 3. The actuator 4 may adjust the cuff 5 to expand or contract, regulating at least some pressure applied by the roller 2. This configuration may allow the user to set a desired compression level through the massager's user interface before or during use. The sensor 8 may monitor such applied pressure, and the microcontroller 7 can adjust the actuator 4 in real-time to maintain consistent compression, enhancing at least some effectiveness of such massage, while ensuring safety and comfort.

The massager may operate without the actuator 1 for both the roller 2 movement and compression force. The user may manually move the cuff over the leg 3, controlling the speed and area of massage. The roller 2 may be designed to rotate freely, facilitating smooth motion as the user guides the cuff 5. Compression may be provided by passive mechanisms, such as springs, elastic bands, or rubber straps integrated into the cuff 5. These elements may exert a consistent pressure onto the leg 3 by naturally adjusting to its contours, ensuring uniform contact and effective massage across different anatomical regions.

Adjustability in compression may be achieved through mechanisms that allow the user to modify at least some tension of the passive components. For example, the cuff 5 may include adjustable slots, buckles, or straps that can be tightened or loosened to increase or decrease a compression force. This enables the user to customize a corresponding pressure according to their comfort level and therapeutic needs without relying on powered actuators. This design may reduce the massager's complexity, weight, and power requirements, making the massager more portable or accessible.

These manual motion embodiments of the cuff 5 offer users greater control over their massage experience. By directly managing the movement of the cuff 5, the user can focus on specific areas that require attention, adjust a speed of movement along the leg 3 or a pressure from the roller 2 intuitively, or respond relatively immediately to sensations of discomfort or relief. Such reduced reliance on actuators may lowers the massager's cost and energy consumption, potentially extending battery life and simplifying maintenance.

Moreover, these configurations retain at least some benefits of the massager's ergonomic design, adjustable cuff, or customizable attachments. The user can still take advantage of interchangeable rollers 2 with different shapes, sizes, and textures to suit various therapeutic purposes. The massager remains adaptable to different body parts and can be used in various positions and settings, such as while sitting, standing, or lying down, or during activities like traveling on a plane, swimming, parachuting, gaming, or others.

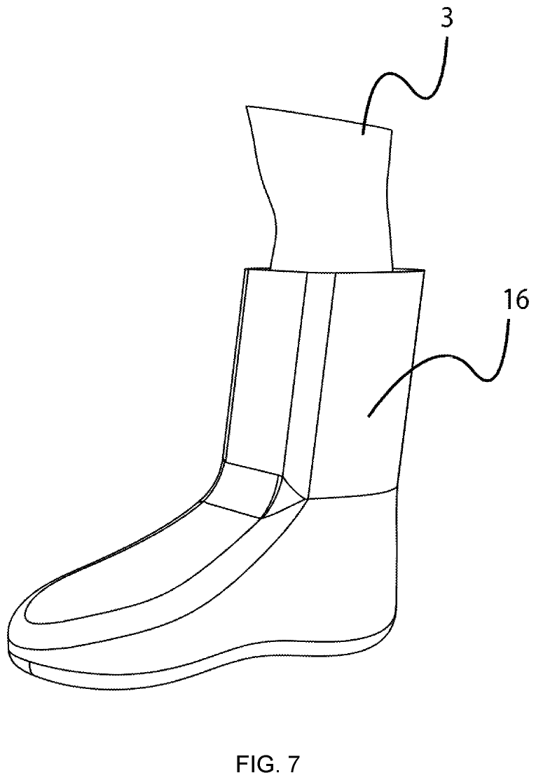

FIG. 7 shows a perspective view of an embodiment of a boot or a leg cover for use with a massager according to this disclosure. In particular, the massager may comprise a cover 16 designed to improve at least some performance or enhance the user's experience in context of the massager. The cover 16 may envelop, enclose, or surround just the leg 3, the cuff 5, or both the leg 3 and the cuff 5. Although the cover 16 is shown embodied as a leg cover or a shoe (e.g., a boot), this configuration is not required and the cover 16 may be embodied differently (e.g., a tube, a tubular member). Likewise, although the cover 16 is shown worn on the leg 3, this configuration is not required and the cover 16 may be worn on any elongated member, whether animate or inanimate, as described herein. For example, the cover (16) can be employed to prevent external elements, such as bed sheets, from interfering with the massage when the user is lying down or attempting to sleep while using the massager. Additionally, the cover 16 can provide thermal insulation, retaining heat generated by the massager or the user's body, thereby offering therapeutic warmth that aids in muscle relaxation. The cover 16 may also contribute to noise reduction, minimizing operational sounds and creating a more relaxing environment. By shielding the cuff 5, the cover 16 may also protect the cuff 5 from dust, debris, and potential damage, potentially extending its lifespan. Furthermore, the cover 16 can enhance safety by preventing accidental contact with moving parts and ensuring proper alignment between the cuff 5 and the leg 3. Constructed from comfortable, perforated, or breathable materials, such as fabric, rubber, wool, linen, cotton, leather, or other suitable materials, the cover 16 improves user comfort during extended use. Incorporating the cover 16 thus enhances the effectiveness, safety, and overall performance of the massager.

FIG. 1 illustrates a means for heating 10 or a means for cooling 17 configured to controllably heat or cool the leg 3 to enhance therapeutic effects or user comfort. The means for heating 10 or the means for cooling 17 may be integrated into various components of the cuff 5, such as inside or outside of the cover 16, within the actuator 1 or the actuator 4, the roller 2, or the cuff 5. For example, the means for heating 10 or the means for cooling 17 may include a heating element, a resistive heating element, a Peltier device for both heating and cooling, a circulation system for heated or cooled fluids, a fan, an ice pack, or another suitable means for heating or means for cooling, which may or may not be powered by the power source 6 or may or may not be controlled by the microcontroller 7. When operative, the means for heating 10 or the means for cooling 17 may aid in muscle relaxation, reduce inflammation, or enhance blood circulation, thereby augmenting at least some overall effectiveness of the massage therapy. The massager (e.g., the cuff 5, the roller 2, the actuator 1, the actuator 4) may include a temperature sensor feeding its sensing data to the microcontroller 7 or a safety mechanism controlled by the microcontroller 7 to monitor or regulate the heating 10 or the means for cooling 17 to control its operation to adjust an ambient or operational temperature, thereby minimizing or preventing overheating or overcooling. The user may adjust at least some temperature settings manually through an interface (e.g., mechanical or virtual), or the massager can automatically adjust temperatures based on sensor feedback or user profiles, synchronizing with massage patterns for a personalized experience. Incorporating heating or cooling elements may thus significantly improve the therapeutic benefits, comfort, or versatility of the massager.

As shown in FIG. 1, the massager may comprise a means for controlling a motion of the roller 2 independently of an overall motion or action of the cuff 5 itself. This functionality may be achieved through an integration of the actuator 11, such as an electric motor (e.g., brushed or brushless), which may enable the roller 2 to perform various mechanical movements that mimic human massage techniques. For example, these motions may include expanding, contracting, inflating, deflating, rolling, tapping, vibrating, spinning, oscillating, kneading, or other suitable movements.

By providing these additional forms of motion, the massager can simulate actions commonly used in human massage therapy, such as tapping, rubbing, rolling, kneading, or others, thereby enhancing at least some therapeutic effects or personalization of the massage experience. Such independent control of the roller 2 may allow for precise modulation of pressure and movement patterns, adapting to the user's specific needs and preferences. The actuator 11 may be programmed to operate in synchronized or asynchronous modes, creating complex massage patterns or sequences.

Furthermore, there may be integration of sensors within the roller 2 or actuator 1 that may provide real-time feedback on operating parameters, such as pressure, speed, or contact quality. This feedback enables the massager to adjust the roller 2 motion dynamically, optimizing the massage based on the user's physiological responses or preset preferences. The actuator 1 may also support three-dimensional movements, allowing the roller 2 to move not only along the surface of the leg 3, but also to apply varying degrees of depth or angles, closely replicating at least some intricacies of a human masseuse's touch.

The massager may include software algorithms that control the actuator 11, enabling a creation of customizable massage programs. The user can select from predefined massage routines or create their own sequences, adjusting factors like intensity, rhythm, and focus areas. Such inclusion of these independently controlled roller 2 with advanced motion capabilities significantly enhances at least some versatility and effectiveness of the massager, thereby providing a more comprehensive, satisfying, or human-like massage experience.

FIG. 1 shows a means for steering the cuff as the cuff moves across the leg 3, thereby enabling precise navigation and enhanced massage delivery. This steering capability is achieved through an integration of the actuator 13, such as an electric motor (e.g., brushed or brushless), dedicated to controlling a direction or orientation of the cuff 5 during movement. The actuator 13 may manipulate steering mechanisms that may include pivoting wheels, adjustable tracks, or articulated joints, allowing the cuff 5 to adjust its path dynamically.

To facilitate effective steering, the massager may incorporate control algorithms that process data from the sensor 12, such as a gyroscope, an accelerometer, an optical sensor, or a tactile sensor, to determine its position, orientation, and proximity to the leg 3. Such control system uses this data to adjust the actuator 1, the actuator 4, the actuator 11, or the actuator 13 in real-time, ensuring that the cuff 5 follows a desired massage path, adapts to the contours of the leg 3, or maintains optimal contact with the skin of the leg 3. This configuration allows the cuff 5 to navigate complex body shapes, focus on specific target areas, or avoid obstacles or sensitive regions.

Such steering mechanism may also include the guide 9 that may assist in maintaining alignment or preventing deviation from an intended path. Software algorithms provide path planning and obstacle avoidance capabilities, thereby enabling personalized massage experiences tailored to the user's specific needs and preferences. By integrating steering functionality, the massager enhances its ability to deliver precise, targeted, or effective massage therapy. This advanced steering system contributes to improved therapeutic outcomes and user satisfaction by maximizing consistent or accurate movement across the leg 3, adapting to individual anatomical differences, or adjusting movements in real-time for optimal performance.

As shown in FIG. 1, the massager may enhance the massage experience by integrating therapeutic light sources, leveraging their benefits to improve comfort and efficacy. As such, the light source 15, which may source an infrared (IR) light, a red light, an ultraviolet (UV) light, or any other suitable wavelengths for at least therapeutic effects, can be incorporated into various components of the massager, such as the roller (2), the cuff 5, or another suitable component of the massager. These light sources may provide deep-penetrating energy that reaches into muscle tissues, thereby promoting increased blood circulation, accelerating healing, or aiding in muscle relaxation, thereby amplifying at least some therapeutic effects of the massage.

The therapeutic light sourced from the light source 15 can be synchronized with the massage patterns, thereby allowing the light intensity to adjust in tandem with the massage motions for a more harmonious experience. The user may have an option to customize the light settings through a user interface (e.g., mechanical or virtual), selecting desired intensity levels or targeting specific areas that may benefit from additional light therapy. The cuff 5 may host various safety mechanisms, including temperature sensors or automatic shut-off features, to ensure that the light exposure remains within safe parameters to prevent overheating or discomfort. Additionally, such integration of therapeutic light may stimulate cellular regeneration or reduce inflammation, thereby contributing to enhanced recovery after physical activity or injury.

By combining at least some mechanical benefits of massage with the therapeutic advantages of light therapy, the massager may offer a comprehensive solution that caters to both relaxation and physical well-being, further personalizing or enriching the user's massage experience.

The massager may incorporate advanced power management and charging solutions to enhance usability and convenience. The massager may utilize the power source 6, such as a battery, a rechargeable lithium-ion battery, strategically placed within the cuff (5) for optimal weight distribution or balance. To facilitate ease of use or maintain the massager's integrity, wireless charging capabilities may be integrated through inductive charging technology (e.g., an inductive receiver) or far-field charging technology (e.g., a far-field receiver) hosted by the cuff 5 to recharge the power source 6 when the power source 6 is a battery (or a capacitor). This configuration may allow the massager to wirelessly charge when placed on a compatible charging dock or pad or positioned within an operation range of a far-field wireless power transmitter, thereby minimizing or without any need for physical connectors, thereby preserving waterproofing or hygiene. Additionally, the microcontroller 7 may host an intelligent energy management system to monitor a battery charge level or optimize power consumption during operation and standby modes. Low-power components or energy-efficient algorithms extend battery life, thereby ensuring the massager being ready for use when needed or reducing frequency of charging cycles. Note that in some embodiments, the massager may recharge the remote control or the remote control may recharge the massager, as described above.

To accommodate the user who may wish to use the massager in various locations, including during travel, the massager may be designed with portability or storage considerations, such as in terms of size, shape, volume, weight, materials, or other suitable characteristics. For example, the cuff 5 and its components may be constructed from lightweight materials, such as aluminum alloys or high-strength polymers, to reduce overall weight with minimal or without compromising durability. The cuff 5 may feature foldable or collapsible elements, allowing the cuff 5 to be compactly stored in a carrying case or bag provided with the massager. Quick-release mechanisms or modular components may enhance ease of assembly or disassembly, thereby enabling the user to transport the massager conveniently in luggage or backpacks. Protective cases not only facilitate portability, but also may shield the massager from damage during transit.

Recognizing an importance of hygiene in when the massager contacts the skin, the massager may incorporate features to facilitate easy cleaning, sterilization, or maintenance. Removable and washable covers or sleeves made from antimicrobial or hypoallergenic materials may be included. These covers or sleeves can be detached from the roller 2, the cuff 5, or other contact points and laundered separately when the massager is not in use, thereby ensuring the massager may remain clean or sanitary between uses. As described above, the materials used may possess antimicrobial properties, such as embedded silver ions or copper fibers, to inhibit bacterial or fungal growth. Additionally, the massager's design may allow for easy disassembly of key components with minimal or without any need for specialized tools, enabling the user to access and clean internal parts as necessary. Sealed or waterproof components may protect internal electronics from moisture during cleaning, and self-cleaning features like UV light sterilization, may further enhance hygiene. In some embodiments, the massager may be sterilized in an autoclave.

Additionally, as described above, the materials selected for construction of the massager may be chosen with consideration for skin compatibility or user comfort. The skin-contact components, including the roller 2, the cuff 5, covers, and attachments, may be made from hypoallergenic materials, such as medical-grade silicone, thermoplastic elastomers, or soft-touch polymers, to minimize risk of allergic reactions and irritation. These materials may be durable and capable of withstanding repeated use with minimal or without any degradation. The massager may utilize breathable fabrics or perforated designs to enhance airflow or reduce buildup of sweat or moisture during extended use. Materials resistant to oils, lotions, or other similar substances commonly encountered during massage therapy may be employed to maintain the massager's appearance or functionality over time.

The massager may be designed to comply with relevant regulatory and safety standards to ensure safe and effective use. The massager may be a medical device or adhere to medical device regulations, such as those set forth by the U.S. Food and Drug Administration (FDA) for Class I or Il medical devices or obtain CE marking for compliance within the European Union or other suitable governmental bodies. Electrical safety standards, including Underwriter Laboratories (UL) certification, may be met to ensure the device operates safely under various conditions. If incorporating IR or UV light or other forms of radiation, then the massager may comply with standards governing electromagnetic emissions and radiation safety, such as IEC 60601-1-2 for medical electrical equipment. Rigorous testing for mechanical safety, biocompatibility, and environmental considerations may ensure that the massager meets international standards like ISO 13485 for medical device quality management systems.

The versatility and advanced features of the massager may make the massager suitable for use in professional and clinical settings. The massager may include a “Therapist Mode” or “Clinician Mode” or another similar mode that allows healthcare providers, such as clinicians, physicians, nurses, therapists, physical therapists, chiropractors, or massage therapists, to customize massage programs for patients based on specific therapeutic goals. This mode offers advanced settings and controls not available in a standard end user interface, thereby enabling precise adjustments to massage parameters. The massager may support remote monitoring capabilities, allowing relevant clinicians, therapists, or other medical or insurance personnel to track patient progress and adjust treatment plans through data sharing, with the patient's consent, via secure communication channels. Integration with electronic health records (EHR) systems may be facilitated through standardized data formats and compliance with healthcare data interoperability standards, thereby enabling seamless incorporation of massage therapy data into the patient's overall medical record.

The massager or the remote control may include features designed to engage users and promote consistent use for better health outcomes. The massager or the remote control may track user progress by recording metrics, such as total massage time, frequency of use, or improvements in biometric indicators. This data can be presented through a corresponding user interface (e.g., mechanical or virtual) or a companion mobile application or a web application interface in an easily understandable format, such as graphs or achievement badges. Users may set wellness goals, receive reminders, or earn rewards for reaching milestones, incorporating elements of gamification to motivate regular use. Social features may allow users to share their progress with friends or participate in community challenges, fostering a sense of community and support. These engagement features enhance user experience or encourage adherence to massage therapy routines.

To provide a comprehensive wellness experience, the massager may integrate with other health devices or platforms. The massager can connect with wearable fitness trackers, heart rate monitors, sleep trackers, smartwatches, and other health tracking computing units to aggregate data that informs massage customization. By accessing data, such as physical activity levels, sleep quality, or stress indicators, the massager may adjust its massage programs to better suit the user's current condition. Integration may be facilitated through standard communication protocols or application programming interfaces (APIs), thereby allowing for seamless data exchange between devices (e.g., the massager, the remote control, the health tracking computing units) and corresponding applications. This interconnected ecosystem enables the user to gain deeper insights into their health and wellness, and the massager may provide recommendations or adjustments based on holistic data analysis.

To enhance user comfort, especially during relaxation or sleep, the massager may incorporate noise reduction technologies. The massager may utilize quiet-operating actuator (1), the actuator (4), the actuator 11, or the actuator 13, such as a brushless DC motor with a low noise emission technology. Sound-dampening materials may be integrated into the cuff (5) or component housings to absorb vibrations or reduce mechanical noise. Vibration isolation techniques, such as mounting components on rubber or silicone gaskets, may minimize or prevent transmission of vibrations to external surfaces. The massager (e.g., the microcontroller 7) may employ active noise cancellation algorithms if equipped with appropriate audio hardware (e.g., microphones, speakers). These measures may ensure that the massager operates quietly, allowing users to enjoy their massage experience without disturbance.

The massager may include safety features tailored to protect vulnerable populations, such as pregnant women, individuals with certain medical conditions, or children. The massager may offer specialized modes or presets, such as a “Pregnancy Mode,” which adjusts massage intensity and avoids certain areas contraindicated during pregnancy. Warnings or notifications may be provided when the massager detects use patterns or settings that could be inappropriate for specific medical conditions, based on user profiles or inputted health information. Child safety locks or parental controls may minimize or prevent unauthorized use by children, thereby ensuring the massager is operated only under appropriate supervision. These safety measures may enhance the massager's suitability for a wide range of users while maintaining safe operation.

To ensure that the user can fully utilize some, many, most, or all features of the massager, comprehensive training and support resources may be provided. The massager may come with detailed user manuals, quick-start guides, and instructional videos accessible through a user interface (e.g., virtual) or companion app. Interactive tutorials may guide the user through initial setup, customization of settings, or maintenance procedures. A robust customer support system, including options for live chat, email, or phone assistance, may be available to address user inquiries and troubleshoot issues. The massager may also feature built-in diagnostics to help users identify or resolve common problems. By offering extensive support, the massager enhances user confidence and satisfaction.

For enhanced safety, especially for users who may be at risk of medical emergencies, the massager or the remote control may integrate emergency response features. The massager can include sensors to detect unusual conditions, such as sudden changes in heart rate or a fall detected through accelerometers. In such events, the massager or the remote control may automatically send alerts to predefined emergency contacts or trigger an audible alarm. An emergency stop mechanism, such as an easily accessible physical button or voice command, allows users to immediately halt the massager's operation if discomfort or an emergency arises. These features provide an additional layer of security and peace of mind for users and their caregivers.

The massager (or its use as described herein) may be associated with a billing code (e.g., HCPCS, CPT) for billing or reimbursement purposes via a medical insurance provider. There may be further sub-codes for various procedures or uses of the massager as described herein, which may depend on medical condition, disorder, disease, timing of use, amount of uses, or other attributes.

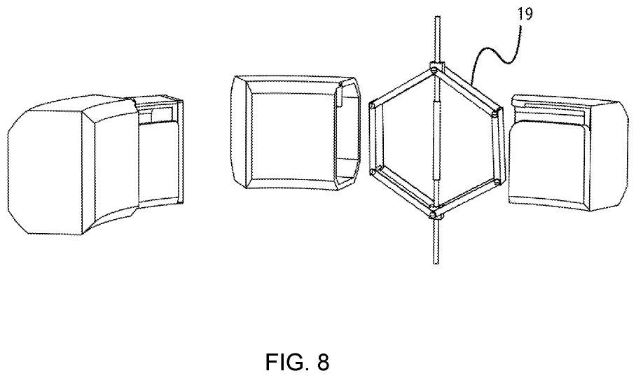

FIG. 8 shows a perspective view of an embodiment of a section of a cuff hosting a scissor mechanism according to this disclosure. In particular, the cuff 5 may host (e.g., internally, externally) a scissor mechanism 19 (e.g., a scissor lift) to control an expansion or contraction, as desired or necessary, for applying a pressure toward the leg 3 during the massage. The scissor mechanism 19 may be powered by the power source 6, driven by an actuator (e.g., 1, 4, 11, 13) on-board of the cuff 5 powered by the power source 6, driven by a spring (e.g., 18) on-board of the cuff 5, a roller (e.g., 2) on-board of the cuff 5 and driven by the actuator on-board, or driven by another component hosted on-board of the cuff 5 and powered by the power source 6.

The scissor mechanism 19 may include a set of linked arms (e.g., struts), at least one of which may be a crossing arm, connected to each other or interconnected by a set of pivot points (e.g., joints), thereby forming a collapsible framework that can extend or retract smoothly when operated. When at least some force is applied, whether manually, passively via a spring, via an actuator, or another suitable force applicator, the scissor mechanism 19 may reshape the cuff 5, whether to expand or contract as appropriate. Retracting movement of the scissor mechanism 19, or vice versa, may enable an increase in the pressure applied to the targeted area. Conversely, extending the scissor mechanism 19, or vice versa, may enable a reduction in the pressure applied to the targeted area. By adjusting a degree of expansion of the scissor mechanism 19, the massager can maintain consistent and controlled pressure as the cuff 5 moves along the leg 3, accommodating contours and ensuring an effective massage. The scissor mechanism 19 provides a mechanical advantage that allows for precise control over pressure intensity while distributing force evenly, thereby enhancing user comfort and the overall efficacy of the massage.

As shown in FIG. 8, the scissor mechanism 19 has a hexagon shape with a vertical bar (e.g., a threaded shaft) skewered through the hexagon shape at two opposing pivot points of the set of pivot points. As such, the hexagon shape has a right portion (e.g., a linkage that is collapsable or expandable) connectable (e.g., attachable, fastened) to a right section (e.g., a cover, a housing) of the cuff 5 and a left portion (e.g., a linkage that is collapsable or expandable) connectable (e.g., attachable, fastenable) to a left section of the cuff 5, where the vertical bar is central to or extends between the right portion and the left portion while the right portion and the left portion are attached at the two opposing pivot points to the vertical bar. Therefore, as the vertical bar is operated (e.g., rotated, spun) while the right portion is connected to the right section of the cuff 5 and the left portion is connected to the left section of the cuff 5, the hexagonal shape expands or collapses depending on how the vertical bar is operated. Such operation of the vertical bar causes the left section of the cuff 5 and the right section of the cuff 5 to respectfully move to or away from the vertical bar, which be reshape the cuff.

Note that although FIG. 8 depicts the scissor mechanism 19 as the hexagon shape with the vertical bar, this configuration is not required and the scissor mechanism 19 may be shaped differently or may lack the vertical bar. For example, the scissor mechanism 19 may be shaped as any suitable type of polygon or non-polygon, whether symmetric or asymmetric, whether closed-shaped or open-shaped. For example, the scissor mechanism 19 may have an X-shape configuration, a crisscross configuration, or another suitable configuration.

Note that any algorithm disclosed herein can be embodied in a non-transitory medium (e.g., a memory) storing a set of instructions executable by a processing unit (e.g., a single core processor, a multicore processor, a PLC, a graphics card, a GPU, a tensor core unit, a TPU, an ASIC, a controller, an edge processor, a SOC, a hardware accelerator, a NN accelerator, a ML accelerator) to perform these actions. For example, the vehicle or the remote control can host the processing unit, whether internally or externally, as described above.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

This disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a port-able compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network, a neutrino network, an optical network (e.g., Li-Fi, fiberoptics), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of this disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer soft-ware, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Features or functionality described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity or actor in any manner.

Although preferred embodiments have been depicted and described in detail herein, skilled persons know that various modifications, additions, substitutions and the like can be made without departing from this disclosure. As such, these are considered to be within the scope of the disclosure, as defined in the following claims.

### NUMBERED ITEMS LIST

1. Actuator (roller motor)
2. Roller
3. Body Part
4. Actuator (pressure motor)
5. Cuff (chassis)
6. Power Source (battery or power supply)
7. Microcontroller
8. Sensor (pressure sensor)
9. Guide (track)
10. Heating element
11 Actuator (tapping, vibrating, etc)
12. Sensor (orientation sensor)
13. Actuator (Steering motor)
14. Muscle tension sensor
15. Light source
16 Boot cover
17 Cooling element
18. Constant force retractor (spring)
19. Scissor mechanism

What is claimed is:

1. A vehicle, comprising:
a cuff mountable on an elongated member such that the elongated member extends through the cuff;
a first actuator attached to the cuff;
a roller attached to the first actuator;
a reshaper attached to the cuff, wherein the reshaper is a second actuator attached to the cuff or a spring attached to the cuff; and
a power source attached to the cuff and configured to power the first actuator such that the first actuator drives the roller to move the cuff along the elongated member and the reshaper reshapes the cuff to generate a pressure towards the elongated member as the cuff moves along the elongated member.

2. The vehicle of claim 1, wherein the cuff has a closed-shape.

3. The vehicle of claim 1, wherein the cuff has an open-shape.

4. The vehicle of claim 1, wherein the elongated member is animate.

5. The vehicle of claim 4, wherein the elongated member is an arm, a leg, a finger, a toe, a neck, or a torso.

6. The vehicle of claim 1, wherein the first actuator is attached mechanically, frictionally, or adhesively to the cuff.

7. The vehicle of claim 1, further comprising:
a microcontroller controlling the first actuator (1).

8. The vehicle of claim 7, further comprising:
a sensor sensing of a presence, an absence, or a change of an object or a property such that the microcontroller determines a spatial relationship between the elongated member and the cuff.

9. The vehicle of claim 8, wherein the sensor is a capacitive sensor, an optical sensor, an infrared sensor, a rotary encoder, a magnetic sensor, a tactile sensor, a force resistive sensor, a load cell, a gyroscopic sensor, an accelerometer, or an inertial measurement unit.

10. The vehicle of claim 1, further comprising:
a sensor sensing the pressure such that the reshaper reshapes the cuff to keep the pressure uniform based on the pressure being sensed as the cuff moves along the elongated member, wherein the cuff, the first actuator, the reshaper, or the roller hosts the sensor.

11. The vehicle of claim 1, further comprising:
a guide configured to guide the roller along the elongated member when the guide extends along or on the elongated member as the roller rolls on the elongated member.

12. The vehicle of claim 1, further comprising:
a third actuator attached to the cuff or the roller, wherein the third actuator massages the elongated member when the third actuator is powered by the power source.

13. The vehicle of claim 1, further comprising:
a third actuator steering the roller when the cuff moves along the elongated member and the third actuator is powered by the power source.

14. The vehicle of claim 1, wherein the elongated member includes a muscle having a tension, and further comprising:
a sensor sensing the tension when the sensor is powered by the power source and the elongated member extends through the cuff.

15. The vehicle of claim 1, further comprising:
a light source providing a light towards the elongated member when the light source is powered by the power source and the elongated member extends through the cuff.

16. The vehicle of claim 1, wherein the cuff hosts a set of rollers including the roller.

17. A method, comprising:
supplying a vehicle to a user accessing an elongated member, wherein the vehicle comprises a cuff, a first actuator, a roller, a reshaper, and a power source, wherein the cuff is mountable on the elongated member such that the elongated member is extendable through the cuff, wherein the first actuator is attached to the cuff, wherein the roller is attached to the first actuator, wherein the reshaper is attached to the cuff, wherein the reshaper is a second actuator attached to the cuff or a spring attached to the cuff, wherein the power source is attached to the cuff, wherein the vehicle is supplied such that the power source powers the first actuator, the first actuator drives the roller to move the cuff along the elongated member, and the reshaper reshapes the cuff to generate a pressure towards the elongated member as the cuff moves along the elongated member.

18. The method of claim 17, wherein the vehicle automatically adjusts (a) its speed of movement along the elongated member, (b) starting its operation along the elongated member, or (c) stopping its operation along the elongated member based on a user-defined schedule, a biometric indicator sensed from the elongated member, a set of sensor data sensed from the elongated member, a voice command from the user, a set of data received from a wearable computer worn by the user, a set of sleep cycle data of the user, a predictive algorithm specific the user, an event-based trigger specific to the elongated member or the user, a detection of stress of the elongated member or the user, a detection of tension of the elongated member or the user, an instruction from a remote control, a proximity of the user to the vehicle, a feedback of the user to the vehicle, a set of location data for the vehicle, the user, or the elongated member, an emergency instruction, a set of sensing data sensed by a sensor spaced apart from the vehicle, or an environmental cue.

19. A method, comprising:
causing a massage of an elongated member of a user by a vehicle, wherein the vehicle comprises a cuff, a first actuator, a roller, a reshaper, and a power source, wherein the cuff is mounted on the elongated member such that the elongated member extends through the cuff, wherein the first actuator is attached to the cuff, wherein the roller is attached to the first actuator, wherein the reshaper is attached to the cuff, wherein the reshaper is a second actuator attached to the cuff or a spring attached to the cuff, wherein the power source is attached to the cuff, wherein the massage is caused based on the power source powering the first actuator, the first actuator driving the roller to move the cuff along the elongated member, and the reshaper reshaping the cuff to generate a pressure towards the elongated member as the cuff moves along the elongated member.

20. The method of claim 19, wherein the reshaper is the second actuator.

21. The method of claim 19, wherein the reshaper is the spring.
